(19) United States
(12) Patent Application Publication
(10) Pub. No.: US 2008/0171557 A1
(43) Pub. Date: Jul. 17, 2008

(54) Method, System and Module for Locating a Telecommunications Terminal

(76) Inventors: Xiang Bernard, Sevres (FR); Guillaume Viel, Boulogne Billancourt (FR); Fabien Dallot, Issy Les Moulineaux (FR); Deborah Baruch, Lonau (CH); Olivier Peridy, Paris (FR)

Correspondence Address: COHEN, PONTANI, LIEBERMAN & PAVANE, 551 FIFTH AVENUE, SUITE 1210, NEW YORK, NY, 10176, US

(21) Appl. No.: 11/578,655

(22) PCT Filed: Apr. 14, 2005
(86) PCT No.: PCT/FR05/00899

§ 371 Date: Oct. 15, 2007

(30) Foreign Application Priority Data
Apr. 14, 2004 (FR) 0403861
Mar. 14, 2005 (FR) 0502453

(51) Int. Cl. H04Q 7/20

(52) U.S. Cl. 455/456.2

(57) ABSTRACT

A system for locating a communications terminal (10). The system comprises a location hybridization module (14) which comprises: a spatial filter (142); a temporal filter (141) for the geographical location adapted to compare a time corresponding to the age of the latest geographical location with a first predetermined maximum time and, in the event of a positive comparison result, to compare said time corresponding to the age of the latest geographical location with a second predetermined maximum time greater than said first predetermined maximum time; a speed filter (145) adapted to compare the speed at which said terminal (10) is moving with a predetermined maximum speed; a module (144) for estimating the uncertainty as to the geographical location; and a selection module (143) adapted to select either the area defined by the latest geographical location or the network-location area. Application is to mobile telephone services that need to know the location of the terminals.

The present invention relates to a telecommunications terminal location method, to a system, and to a module.

The invention finds a particularly advantageous application in the field of mobile telephone services that need to know the locations of terminals, such as emergency and assistance services and vehicle fleet management services (haulage, deliveries).

There are several techniques for locating a telecommunications terminal, such as a mobile telephone.

A first technique is based on the cellular telecommunications network to which the mobile telephone belongs, for example a GSM/GPRS network. Several location methods based on said network have been standardized (3GPP GSM 03.71, TS 22.071).

The most widely used method of this type is that known as the “Cell_id” method, which determines the location of the terminal by identifying the cell to which the mobile telephone is attached. The “Enhanced Cell_id” method is an improvement on the above method that refines the location process by measuring the return trip time relative to an antenna of the cell. Other methods use triangulation, such as the E-OTD (Enhanced Observed Time Difference), and TOA (Time Of Arrival) methods.

All those methods for determining what is called the network-location of the terminal have the common feature of locating a mobile terminal in standby or connected mode in any area covered by the network, the GSM network in this example.

A terminal may also be located using purely geographical location technologies, such as satellite technologies, one example of which is the GPS (Global Positioning System). The GPS uses a constellation of 24 satellites so that at least six satellites are in view anywhere on the globe at any time. Terminals integrating a GPS receiver are then able to compute their GPS position from the known distances between the receiver and three, or even four or more, satellites of the GPS constellation. These distances are computed from the measured travel time of signals sent by the satellites.

A terminal is known in the art that includes both a GSM network-based location module and a geographical location module with the facility to feed the GPS position and the network information to a location server. Those terminals were developed by the Finnish company Benefon, which, in international application WO 01/60100, describes a protocol based on the SMS (Short Message System) technology that sends location requests from a mobile terminal or from a server to a mobile equipped with the Benefon system, and recovers the GPS position of the terminal encapsulated in an SMS message.

Finally, CDMA networks use a location technology known as GPSOne based on a technique that hybridizes the GPS and AFLT (Advanced Forward Link Trilateration) methods.

The GPSOne location technique is one of a set of solutions developed around methods that are the subject matter of international applications WO 03/052451 and WO 01/48506. Those solutions are based on determining the position of a mobile terminal from computations performed on received signal measurements. If the number of satellites is insufficient to determine the GPS position of the terminal, measurements of signals received from terrestrial radio equipments (antennas of the mobile network concerned) are combined with measurements of signals received from the satellites that have been detected. The measurements are then used to establish a system of equations that is then solved to obtain an estimate of the position of the mobile terminal. To summarize, those prior are solutions rely on signal measurements to compute a position.

However, the above location techniques known in the art have a number of drawbacks.

In terms of accuracy, network-location systems of the GSM type do not address the requirements of services such as navigation and emergency services. In fact, the accuracy of those systems is highly variable and depends on the size of the network-location area in the cell to which the terminal is attached. That size may vary from a radius of a few hundred meters in urban areas to 30 kilometers (km) in rural areas.

Location systems based on the GPS offer enhanced performance in terms of accuracy but do not offer the same guarantees in terms of availability and response times, especially in a covered environment. The uncertainty as to the GPS location varies from 10 meters (m) to 100 m in an open environment, which is therefore generally smaller than the GSM location area, with a computation time that can be as much as several minutes. Unfortunately, the GPS is inoperative in a covered environment. This is why it does not address the requirements of emergency services, which may be called out at any time in highly varied environments.

The GPSOne location solution was designed for CDMA networks and has not yet been deployed on GSM networks.

Moreover, GPSOne is based on solving equations involving GPS signal measurements and CDMA network measurements to determine position. The solutions of the equations may be ambiguous if terrestrial signal measurements are introduced, and it is necessary to eliminate the least probable solutions and to use error detector algorithms. The reliability of that technology is therefore greatly dependent on how the received signals have been degraded. If those signals suffer multiple reflections and interference, the error rate can be high. In order to obtain optimum performance, GPSOne requires solutions to be implemented on board the terminal, which renders that solution complex and relatively inflexible.

Finally, introducing a new radio technology or a new location technique implies defining of a new solution taking account of a new equation.

Thus the technical problem to be solved by the subject matter of the present invention is to propose a method of locating a telecommunications terminal belonging to a cellular telecommunications network adapted to supply a location of said terminal, called its network-location, within a network-location area, the terminal being additionally equipped with a geographical location system adapted to supply a geographical location of said terminal, which method should be able to determine the location and to improve its quality in terms of availability, reliability and accuracy, regardless of the environment of the terminal.

The solution of the present invention to the stated technical problem consists in that the method comprises the following steps:

1) first temporal filtering of the geographical location by comparison of a time corresponding to the age of the latest geographical location and a first predetermined maximum time;

2) in the event of a negative comparison result, selecting an area defined by the latest geographical location; and

3) in the event of a positive comparison result, selecting the network-location area.

The comparison result is deemed positive if the age of the latest geographical location is strictly greater than the first predetermined maximum duration (above-specified step 3).

The comparison result is deemed negative if the age of the latest geographical location is less than or equal to the first predetermined maximum duration (above-specified step 2).

Thus the method of the invention evaluates the reliability of the location supplied by the geographical location system, for example the GPS, and retains that location if it is recognized as reliable. In the contrary case, it is the network-location area that is retained.

One particular implementation of the method further comprises the following steps:
for the step 2), spatial filtering of the geographical location by comparison with the network-location area;
   a) if the geographical location is outside the network-location area, estimating an uncertainty as to the geographical location; and
   b) if the geographical location is not outside the network-location area, selecting the area defined by the latest geographical location;
for the step 3), spatial filtering of the geographical location by comparison with the network-location area;
   a) if the geographical location is outside the network-location area, selecting the network-location area; and
   b) if the geographical location is not outside the network-location area:

i) second temporal filtering of the geographical location by comparing the time corresponding to the age of the latest geographical location with a second predetermined maximum time greater than the first predetermined maximum time and comparing the speed at which the terminal is moving to a predetermined maximum speed;

ii) in the event of a negative comparison result, estimating an uncertainty as to the geographical location; and

iii) in the event of a positive comparison result, selecting the network-location area.

In this particular implementation, the comparison result is deemed positive if the age of the latest geographical location is strictly greater than the first predetermined maximum duration (preamble of the above-specified step 3) or if, firstly, the duration corresponding to the age of the latest geographical location is strictly greater than the second predetermined maximum duration and, secondly, the speed at which the terminal is moving is strictly greater than the predetermined maximum speed (above-specified step 3)b)iii).

In this particular implementation, the comparison result is deemed negative if the age of the latest geographical location is less than or equal to the first predetermined maximum duration (above-mentioned step 2) or if, firstly, the duration corresponding to the age of the latest geographical location is less than or equal to the second predetermined maximum duration and, secondly, the speed at which the terminal is moving is less than or equal to the predetermined maximum speed (above-mentioned—step 3)b)ii).

Accordingly, in this particular embodiment, the method of the invention evaluates the reliability of the location supplied by the geographical location system, for example the GPS, and retains that location if it is recognized as reliable, it is the network-location area or the estimate of the uncertainty as to the geographical location that is retained. Here the reliability criterion consists of the age (or the seniority) of the latest geographical location, the consistency between the geographical location and the network-location area, and the speed at which the terminal is moving.

If the geographical location is retained, its accuracy may be improved, as in above-mentioned steps 2) and 3)b).

In another preferred implementation of the method of the invention, estimating the uncertainty as to the geographical location includes:
computing the distance traveled by the terminal during the time corresponding to the age of the latest geographical location;
comparing the computed distance with the size of the area defined by the latest geographical location and the size of the network-location area; and

if the distance computed is between those sizes, establishing that the uncertainty as to the geographical location is defined by an area of an extent that is equal to the computed distance.

The present invention also provides a system for locating a telecommunications terminal belonging a cellular telecommunications network comprising a location server able to acquire a location of the terminal in the cellular network called its network-location within a network-location area and a geographical location of the terminal supplied by a geographical location system of the terminal, the system being characterized in that it comprises a location hybridization module comprising:
a temporal filter for the geographical location able to compare a time corresponding to the age of the latest geographical location with a first predetermined maximum time; and
a selection module adapted to select:
   the area defined by the latest geographical location in the even of a negative comparison result; and
   the network-location area in the event of a positive comparison result.

In one particular embodiment of the system for locating a telecommunications terminal:
the temporal filter for the geographical location is adapted to compare a time corresponding to the age of the latest geographical location with a first predetermined maximum time and, in the event of a positive comparison result, further to compare the time corresponding to the age of the latest geographical location with a second predetermined maximum time greater than the first predetermined maximum time,

and wherein the location hybridization module further comprises:
a spatial filter that is adapted to compare the geographical location with the network-location area;
a speed filter that is adapted to compare the speed at which the terminal is moving with a predetermined maximum speed if the time corresponding to the age of the latest geographical location is greater than the first predetermined maximum time; and
a module for estimating the uncertainty as to the geographical location, which is activated either if the geographical location is outside the network-location area if the time corresponding to the age of the latest geographical location is less than or equal to the first predetermined maximum time or in the event of a negative comparison result between the time corresponding to the age of the latest geographical location and the second predetermined maximum time and between the speed at which the terminal is moving and the predetermined maximum speed,

and in which the selection module is adapted to select:
the area defined by the latest geographical location if the time corresponding to the age of the latest geographical location is less than or equal to the first predetermined maximum time and the geographical location is not outside the network-location area; and
the network-location area either if the time corresponding to the age of the latest geographical location is greater than the first predetermined maximum time and the geographical location is outside the network-location area or in the event of a positive comparison result between the time corresponding to the age of the latest geographical location and the second predetermined maximum time and between the speed at which the terminal is moving around and the predetermined maximum speed.

In another preferred embodiment of the system according to the invention, the module for estimating the uncertainty as to the geographical location comprises:
a sub-module for computing the distance traveled by the terminal during the time corresponding to the age of the latest geographical location;
a sub-module for comparing the computed distance to the size of the area defined by the latest geographical location and the size of the network-location area; and
a sub-module for establishing that the uncertainty as to the geographical location is defined by an area of a size that is equal to the computed distance if the distance is between those sizes.

The present invention further provides to a module for hybridization of the location of a telecommunications terminal belonging to a cellular telecommunications network, the cellular network being able to supply a location of the terminal called its network-location within a network-location area, the terminal being further equipped with a geographical location system adapted to supply a geographical location of the terminal.

This kind of module is noteworthy in that it comprises:
a spatial filter that is adapted to compare the geographical location with the network-location area;
a temporal filter for the geographical location that is adapted to compare a time corresponding to the age of the latest geographical location with a first predetermined maximum time and, in the event of a positive comparison result, to compare the time corresponding to the age of the latest geographical location with a second predetermined maximum time greater than the first predetermined maximum time;
a speed filter adapted to compare the speed at which the terminal is moving with a predetermined maximum speed if the time corresponding to the age of the latest geographical location is greater than the first predetermined maximum time;
a sub-module for estimating the uncertainty as to the geographical location which is activated either if the geographical location is outside the network-location area if the time corresponding to the age of the latest geographical location is less than the first predetermined maximum time or in the event of a positive comparison result between the time corresponding to the age of the latest geographical location and the second predetermined maximum time and between the speed at which the terminal is moving and the predetermined maximum speed; and
a selection sub-module adapted to select:
   the area defined by the latest geographical location if the time corresponding to the age of the latest geographical location is less than the first predetermined maximum time and the geographical location is not outside the network-location area; and
   the network-location area either if the time corresponding to the age of the latest geographical location is greater than the first predetermined maximum time and the geographical location is outside the network-location area or in the event of a negative comparison result between the time corresponding to the age of the latest geographical location and the second predetermined maximum time and between the speed at which the terminal is moving around and the predetermined maximum speed.

The present invention finally provides a software module stored on a data medium including software instructions for executing the location method of the invention.

The following description with reference to the appended drawings, which are provided by way of non-limiting example, explains in what the invention consists and how it may be reduced to practice.

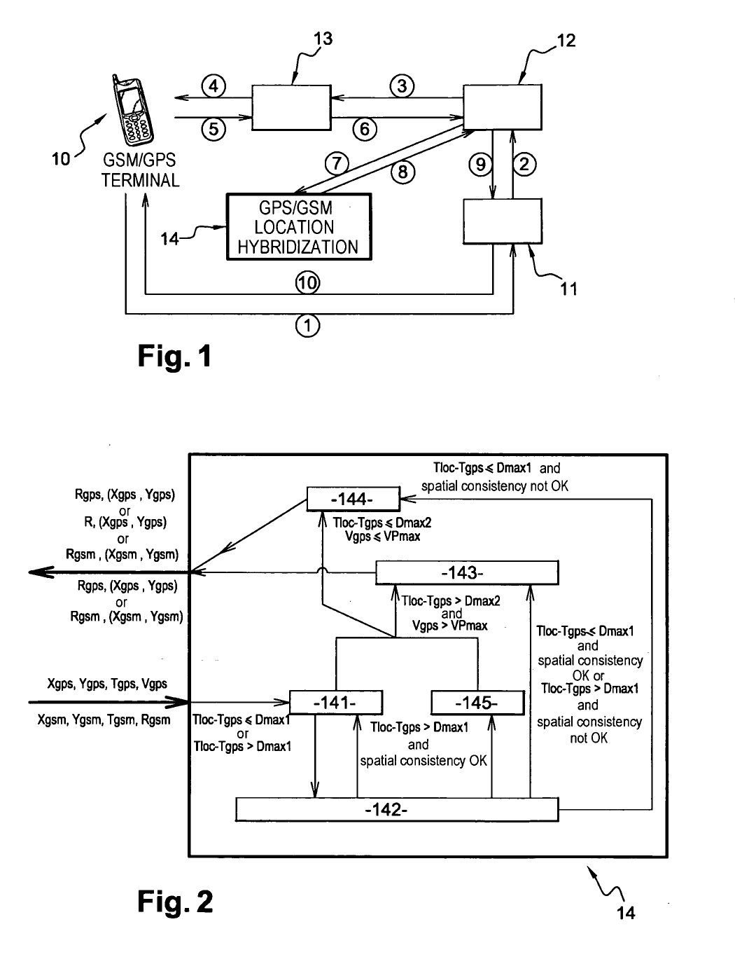

FIG. 1 is a diagram of one particular embodiment of a location system conforming to the invention.

FIG. 2 is a diagram of one particular embodiment of a location module conforming to the invention.

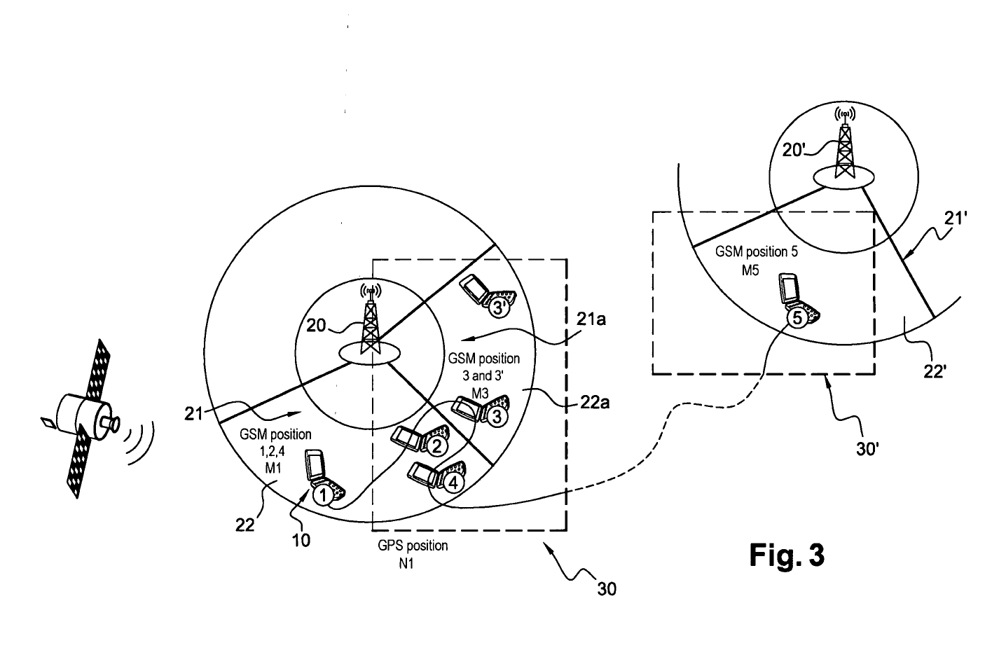

FIG. 3 is a diagram showing one example of the application of a particular embodiment of a location system and method conforming to the invention.

FIG. 1 shows a system for locating a telecommunications terminal 10, for example a mobile telephone belonging to a GSM/GPRS cellular telecommunications network.

As can be seen in FIG. 3, the network is able to supply a location, called the network-location, of the terminal 10 within a network-location area. Said network-location may be defined by the position of the antenna 20, 20′ of a cell 21, 21a, 21′ of the network in which the terminal 10 is situated. The network-location area may be the coverage area 21, 21a, 21′ of the antenna in the cell or a smaller area 22, 22a, 22′ (ring portion) if the antenna 20, 20′ is able to locate the terminal 10 with greater accuracy on the basis of an exchange of signals, for example by measuring a round-trip time between the antenna 20, 20′ and the terminal 10.

Moreover, the terminal 10 is equipped with a geographical location system, such as the GPS, able to supply a geographical location of the terminal 10 with an uncertainty that is generally less than the size of the network-location area.

The FIG. 1 location system works in the following manner.

The user connects a terminal 10 to a service (step 1) and launches an application 11 that needs a very reliable location of the terminal. One such application is an emergency or assistance service, for example, or the management of a fleet of haulage or delivery vehicles.

The application sends a location request to a mediation platform 12 (step 2) which in turn sends a location server 13 a request that contains a GPS and GSM location request (step 3).

The location server 13 interacts with the terminal 10 and the GSM network (steps 4, 5) to compute or recover the GPS position and the GSM position and returns those positions to the mediation platform 12 (step 6).

The mediation platform 12 sends a location hybridization module 14 the GPS position, the time and date of the GPS position, the GSM position, the time and date of the GSM position, and the size of the GSM location area (step 7). Note that the location hybridization module 14 may or may not be an integral part of the mediation platform 12.

In response (step 8), the location hybridization module 14 returns the location that it estimates to be the most reliable, after carrying out the location procedure described below with reference to FIG. 2.

The module 14 receives as input the GPS geographical location of the terminal 10 defined by coordinates Xgps, Ygps, the date and time Tgps of that location and the instantaneous speed Vgps at which the terminal 10 is moving. The module 14 also receives the GSM network-location defined by the coordinates Xgsm, Ygsm, the location date and time Tgsm, and the size Rgsm of the network-location area defining the uncertainty as to the network-location.

As can be seen in FIG. 2, the location hybridization module 14 comprises a temporal filter 141 that serves to compute the age of the GPS geographical location in order to deduce if it is pertinent and usable. To this end, if Tloc is the current reference time for processing data, the filter 141 computes the quantity Tloc−Tgps corresponding to the age of the GPS location and compares it to a first predetermined maximum Dmax1, for example a duration of 60 seconds.

In the event of a negative comparison result, i.e. if (Tloc−Tgps)≦Dmax1, a spatial filter 142 of the location hybridization module 14 for verifying the spatial consistency of the geographical and network locations, verifies if the GPS location retained after time-domain filtering is in fact in the network-location area.

If so, the GPS location is recognized by a selection module 143 as reliable and pertinent and the area defined by that location is retained as the location of the terminal 10.

Else, an uncertainty estimator module 144 supplies an uncertainty associated with the retained geographical location.

To this end, the module 144 computes the distance R traveled by the terminal 10 during the time period t=Tloc−Tgps.

If Vgps<VPmax, then:

R=Vgps*t

(assuming that acceleration has no effect)

Else:

If Vgps<VCmax and t<tf, then:

R=Amax*t²/2+Vgps*t

If Vgps<VCmax and t>tf, then:

R=VCmax*t−(VCmax−Vgps)²/(2*Amax)

If Vgps>VCmax, then R=Vgps*t

where:
VPmax is the maximum speed of a pedestrian (e.g. 5 kilometers per hour (km/h)) carrying the terminal 10;
VCmax is the maximum speed of a vehicle (e.g. 50 km/h) containing the terminal 10;
Amax: is the maximum acceleration of a terrestrial motor vehicle containing the terminal 10; and
it is the time over which a vehicle moving at a speed<VCmax accelerates to the speed VCmax.

Thus tf takes the value (VCmax−Vgps)/Amax.

The estimator module 144 then compares the computed distance R to the size of the area defined by the latest geographical location Rgps and the size of the network-location area Rgsm.

If R>Rgsm, the network-location area is considered more reliable.

If Rgps<R<Rgsm, the location is represented by a circle centered on the latest geographical location with a radius whose value is the distance R computed previously.

If R<Rgps, the area defined by the geographical location is considered more reliable.

In the event of a positive comparison result, i.e. if (Tloc−Tgps)>Dmax1, the spatial filter 142 of the location hybridization module 14 verifies whether the GPS location retained after temporal filtering is in the network-location area or not.

If the GPS location retained is not in the network-location area, the network-location area is recognized by the selection module 143 as reliable and pertinent and is retained as the location of the terminal 10.

Otherwise, if the GPS location retained is in the network-location area, the filter 141 computes the quantity Tloc−Tgps corresponding to the age of the GPS location and compares it to a second predetermined maximum duration Dmax2 greater than Dmax1 and having a value of 3 minutes, for example. Furthermore, a speed filter 145 of the location hybridization module 14 compares the instantaneous speed Vgps at which the terminal 10 is moving to a maximum speed VPmax having a value of 5 km/h, for example.

If Tloc−Tgps>Dmax2 and Vgps>VPmax, the network-location area is recognized by the selection module 143 as reliable and pertinent and is retained as the location of the terminal 10.

Else, the uncertainty estimator module 144 supplies an uncertainty associated with the geographical location retained, in the manner described above.

The location hybridization module 14 is an electronic data processing system that executes the various steps of the location method described above under the control of software instructions. To this end, the location hybridization module 14 comprises a hardware storage medium (not shown) holding those instructions. This support may be a CD-ROM, for example, a magnetic diskette or a hard disc.

FIG. 3 shows an application of the location system and method that has just been described with reference to FIGS. 1 and 2.

In this example there are two different types of environment: an open environment, in which a GPS location can be computed, and a covered environment 30, 30′, in which the absence of a signal prevents obtaining a GPS location. As it moves around, the terminal 10 passes from an open environment (state 1) to a covered environment (state 2) and remains in that environment (state 3 or 3′, then state 4). The terminal 10 is then switched off, and subsequently switched on when it is again in a covered environment (state 5). The terminal 10 is located successively in the states 1, 2, 3, or 3′, 4, 5.

When it is switched on, the mobile terminal 10 is connected to the GSM network. It can therefore be located with the aid of GSM information, which includes in particular the location of the antenna 20, 20′ and the network-location area 22, 22a, 22′, which may be the same size as the cell 21, 21a, 21′ or smaller, as indicated above.

The GSM locations relating to the states 1, 2, and 4 are identical and are marked by the position Ml. The GSM locations relating to the states 3 and 3′ are identical (position M3). The GSM location relating to the state 5 is marked by the position M5. The GPS position is marked by N1.

In the initial open environment (state 1), the GPS position is considered to be regularly updated and therefore accurate. Furthermore, it is assumed that:
the terminal 10 is moving at pedestrian speed (<5 km/h in the present example) between the states 1, 2, 3, 4, and 5;
the terminal 10 is moving at motor car speed (>5 km/h in the present example) between the states 2 and 3′.

Finally, it is also assumed that a certain time elapses between the state 4 and the state 5.

The mobile terminal 10 is initially in an open environment. It is in a GSM coverage area and, moreover, is able to use a GPS location mode. The method of the invention therefore has available a position (M1) for the terminal estimated using the GSM data and a GPS position (N1) that is regularly updated. The method first checks the seniority of the GPS position. The date and time of acquisition of the GPS position enable the method to estimate the validity of that position. In the context of the FIG. 3 example, the GPS position is sufficiently recent (<60 seconds (s)) to be considered temporally reliable.

The method then checks the geographical consistency of the GPS position (N1) and the GSM position (M1). The two positions belong to the same geographical area and are therefore consistent. The method retains the GPS position (N1) as the more reliable position in this situation and the accuracy of the GPS position may be retained for the location.

The terminal 10 then enters a building (state 2) and is consequently in a covered environment when it is located. It therefore cannot acquire a GPS position. The location method then has the GSM position (M1) of the terminal, identical to the GSM position of state 1, and the GPS position (N1) previously calculated in state 1. In this example, the terminal 10 moves quickly from state 1 to state 2 and the time that elapses between the location of the terminal in the state 2 and the location of the terminal in the state 1 is sufficiently short for the method to consider the GPS position temporally valid. However, the distance between the state 1 and the state 2 of the terminal is also sufficiently short for the GPS position in the state 1 to be spatially valid for the state 2, i.e. for the terminal 10 to remain in the coverage of the same cell 21 or in the same network-location area 22. The method therefore considers the GPS position (N1) of the state 1 as the more reliable position for the state 2.

The terminal 10 continues to move around inside the building 30. Two situations may arise. During exactly the same time period, at the speed of a pedestrian, the terminal 10 is located in the state 3, whereas at the speed of a motor car, the terminal 10 is located in the state 3′. The GPS position returned to the location method still corresponds to the GPS position (N1) in the state 1 since, being in a covered environment, it has not been able to acquire a new GPS position. Having changed GSM coverage area, the GSM position (M3) differs from the GSM position (M1) of the states 1 and 2. As for the state 2, it is considered that the time that elapses between the location of the terminal in the state 3 and the location in the state 1 is sufficiently short (<60s) for the method to consider the GPS position (M1) temporally valid. Under such circumstances geographical checking of the GSM position (M3) and the GPS position (N1) reveals an inconsistency since the terminal 10 is in the coverage of the cell 21a or in another network-location area 22a.

In such circumstances, to be able to give results that are adapted to the states 3 and 3′, which are in reality relatively distant, the method takes account of a new item of data, namely the instantaneous horizontal speed Vgps at which the terminal 10 is moving. The aim is to estimate the maximum distance D that the terminal 10 can travel during the time that elapses between the time at which the GPS position (N1) is recorded and the time of location in the state 3 or 3′. For pedestrians, the speed is upped to 5 km/h, whereas for vehicles the distance D is an estimate based on realistic hypotheses based on the acceleration and maximum speed of a standard terrestrial vehicle. In the present example, it is a question of computing the distances between the states 1 and 3 and the states 1 and 3′.

As described above, this computed distance is then compared with the GPS accuracy radius and the GSM accuracy radius.

If the value of the distance computed is between these two comparison values, the method retains the GPS position as the more reliable one for the state 3 or 3′, defining the area of uncertainty around the GPS position as having a radius equal to this computed distance.

If the value of the distance computed is strictly less than the GPS accuracy radius, the method considers the GPS position (N1) of the state 1 as the more reliable position for the state 3 or 3′.

If the computed value of the distance is strictly greater than the GSM accuracy radius, the method considers the GSM position (M3) as the more reliable position for the state 3 or 3′.

The terminal 10 is still moving around inside the building 30 when it is located in the state 4. At the time of its location, the GPS position supplied by the terminal 10 is the position N1 and the GSM data supplied indicates that the time D that has elapsed between the time at which the latest GPS position (N1) was recorded in the terminal 10 and the time of its location in the state 4 is too long for the GPS position (N1) to be considered sufficiently recent. The method then checks the geographical consistency of the GPS position (N1) and the GSM position (M1). The two positions are in the same geographical area and are therefore consistent.

Under such circumstances, the location method effects a second verification of the date and the time of the GPS position (N1) in order to find out if the time D is short enough for the instantaneous speed Vgps at which the terminal 10 is moving and the GPS position to remain pertinent. In fact, the longer the time D, the greater the probability of a change of speed and position. In the present example, the time D is compared with a maximum time of three minutes. The location method also verifies that said instantaneous speed Vgps at which the terminal 10 is moving is not too high. In the present example, the speed Vgps is compared to a maximum speed of 5 km/h (pedestrian speed). If the terminal 10 is moving too fast (at a speed greater than that of a pedestrian, for example), although the time D is short, the uncertainty as to the variation of speed and position remains high.

Consequently, the second verification of the date and the time and the verification of the value of the speed are conditions that can guarantee that the GPS position (N1) remains valid even though the first temporal verification has failed.

In the present example, it is considered that the time D is less than three minutes and that the instantaneous speed of movement is similar to that of a pedestrian.

The distance traveled during said time D is then computed, after which, as described above, this computed distance is compared with the GPS accuracy radius and the GSM accuracy radius.

If the computed value of the distance is between these two comparison values, the method retains the GPS position as the more reliable one for the state 4, defining the area of uncertainty around the GPS position as having a radius equal to the computed distance.

If the computed value of the distance is strictly less than GPS accuracy radius, the method considers the GPS position (N1) of the state 1 the more reliable position for the state 4.

If the computed value of the distance is strictly greater than GSM accuracy radius, the method considers the GSM position M1 the more reliable position for the state 4.

The terminal 10 is then switched off over a portion of its passage from the state 4 to the state 5, and then switched on again inside the building 30′. It is located in step 5. The GPS position supplied to the location method is the position N1 acquired when the terminal was in an open environment in the state 1. It has not been able to acquire a more recent GPS position. The GSM position M5 that is sent back is up to date and corresponds to the network-location area 22′ of the cell 21′ in which the terminal is situated (state 5). The temporal filtering applied to the GPS position rejects the GPS position as being too old. The spatial filtering also fails because the GPS position (N1) and the GSM position (M5) are not situated in the same geographical area. The method therefore retains the GSM position of the state 5 as the more reliable position and indicates the corresponding uncertainty.

1. A method of locating a telecommunications terminal belonging to a cellular telecommunications network able to supply a location of said terminal (10) called its network-location within a network-location area, the terminal (10) being further equipped with a geographical location system able to supply a geographical location of said terminal, wherein the method comprises the following steps:
1) first temporal filtering of the geographical location by comparison of a time corresponding to the age of the latest geographical location and a first predetermined maximum time;
2) in the event of a negative comparison result, selecting an area defined by said latest geographical location; and
3) in the event of a positive comparison result, selecting said network-location area.

2. The method according to claim 1 of locating a telecommunications terminal (10) further comprising the following steps:
for the step 2), spatial filtering of the geographical location by comparison with said network-location area;
a) if said geographical location is outside the network-location area, estimating an uncertainty as to the geographical location; and
b) if said geographical location is not outside the network-location area, selecting the area defined by said latest geographical location;
for the step 3), spatial filtering of the geographical location by comparison with said network-location area;
a) if said geographical location is outside the network-location area, selecting said network-location area; and
b) if said geographical location is not outside the network-location area:
i) second temporal filtering of the geographical location by comparing said time corresponding to the age of the latest geographical location with a second predetermined maximum time greater than said first predetermined maximum time and comparing the speed at which said terminal (10) is moving to a predetermined maximum speed;
ii) in the event of a negative comparison result, estimating an uncertainty as to the geographical location; and
iii) in the event of a positive comparison result, selecting said network-location area.

3. The method according to claim 2, wherein said estimation of the uncertainty as to the geographical location comprises:
computing the distance traveled by said terminal during the time corresponding to the age of the latest geographical location;
comparing the computed distance with the size of the area defined by the latest geographical location and the size of the network-location area; and
if the distance computed is between said sizes, establishing that the uncertainty as to the geographical location is defined by an area of an extent that is equal to said computed distance.

4. A system for locating a telecommunications terminal (10) belonging a cellular telecommunications network comprising a location server (13) able to acquire a location of the terminal (10) in said cellular network called its network-location within a network-location area and a geographical location of the terminal supplied by a geographical location system of the terminal (10), wherein the system being comprises a location hybridization module (14) comprising:
a temporal filter (141) for the geographical location able to compare a time corresponding to the age of the latest geographical location with a first predetermined maximum time; and
a selection module (143) adapted to select:
the area defined by the latest geographical location in the even of a negative comparison result; and
the network-location area in the event of a positive comparison result.

5. The system according to claim 4 for locating a telecommunications terminal (10), wherein:
the temporal filter (141) for the geographical location is adapted to compare a time corresponding to the age of the latest geographical location with a first predetermined maximum time and, in the event of a positive comparison result, further to compare said time corresponding to the age of the latest geographical location with a second predetermined maximum time greater than said first predetermined maximum time,
and wherein the location hybridization module (14) further comprises:
a spatial filter (142) that is adapted to compare said geographical location with said network-location area;
a speed filter (145) that is adapted to compare the speed at which said terminal (10) is moving with a predetermined maximum speed if the time corresponding to the age of the latest geographical location is greater than the first predetermined maximum time; and
a module (144) for estimating the uncertainty as to the geographical location, which is activated either if the geographical location is outside the network-location area if the time corresponding to the age of the latest geographical location is less than or equal to the first predetermined maximum time or in the event of a negative comparison result between the time corresponding to the age of the latest geographical location and the second predetermined maximum time and between the speed at which said terminal (10) is moving and the predetermined maximum speed,
and in which the selection module (143) is adapted to select:
the area defined by the latest geographical location if the time corresponding to the age of the latest geographical location is less than or equal to the first predetermined maximum time and said geographical location is not outside the network-location area; and
the network-location area either if the time corresponding to the age of the latest geographical location is greater than the first predetermined maximum time and said geographical location is outside the network-location area or in the event of a positive comparison result between the time corresponding to the age of the latest geographical location and the second predetermined maximum time and between the speed at which said terminal (10) is moving around and the predetermined maximum speed.

6. The location system according to claim 5, wherein said module (144) for estimating the uncertainty as to the geographical location comprises:
means for computing the distance traveled by said terminal (10) during the time corresponding to the age of the latest geographical location;
means for comparing the computed distance with the size of the area defined by the latest geographical location and the size of the network-location area; and
means for establishing that the uncertainty as to the geographical location is defined by an area of a size that is equal to said computed distance if the distance is between said sizes.

7. A module for hybridization of the location of a telecommunications terminal (10) belonging to a cellular telecommunications network, said cellular network being able to supply a location of said terminal called its network-location within a network-location area, said terminal (10) being further equipped with a geographical location system adapted to supply a geographical location of said terminal (10), wherein said location hybridization module (14) comprises:
a spatial filter (142) that is adapted to compare said geographical location with said network-location area;
a temporal filter (141) for the geographical location that is adapted to compare a time corresponding to the age of the latest geographical location with a first predetermined maximum time and, in the event of a positive comparison result, to compare said time corresponding to the age of the latest geographical location with a second predetermined maximum time greater than said first predetermined maximum time;
a speed filter (145) adapted to compare the speed at which said terminal (10) is moving with a predetermined maximum speed if the time corresponding to the age of the latest geographical location is greater than the first predetermined maximum time;
a module (144) for estimating the uncertainty as to the geographical location which is activated either if the geographical location is outside the network-location area if the time corresponding to the age of the latest geographical location is less than the first predetermined maximum time or in the event of a positive comparison result between the time corresponding to the age of the latest geographical location and the second predetermined maximum time and between the speed at which said terminal (10) is moving and the predetermined maximum speed; and
a selection module (143) adapted to select:
the area defined by the latest geographical location if the time corresponding to the age of the latest geographical location is less than the first predetermined maximum time and said geographical location is not outside the network-location area; and
the network-location area either if the time corresponding to the age of the latest geographical location is greater than the first predetermined maximum time and said geographical location is outside the network-location area or in the event of a negative comparison result between the time corresponding to the age of the latest geographical location and the second predetermined maximum time and between the speed at which said terminal (10) is moving around and the predetermined maximum speed.

8. The location hybridization module according to claim 7, wherein said module (144) for estimating the uncertainty as to the geographical location comprises:
means for computing the distance traveled by said terminal (10) during the time corresponding to the age of the latest geographical location;
means for comparing the computed distance with the size of the area defined by the latest geographical location and the size of the network-location area; and
means for establishing that the uncertainty as to the geographical location is defined by an area of a size that is equal to said computed distance if the distance is between said sizes.

9. A software module stored on a data medium including software instructions for having executed the location method according to claim 2.

10. A software module stored on a data medium including software instructions for having executed the location method according to claim 3.
